(19) United States
(12) Patent Application Publication
(10) Pub. No.: US 2019/0039662 A1
(43) Pub. Date: Feb. 7, 2019

(54) HEIGHT-ADJUSTABLE ENCLOSED TRAILER WITH TELESCOPING VERTICAL SUPPORTS

(71) Applicant: Steven Dack, Oakdale, CA (US)

(72) Inventor: Steven Dack, Oakdale, CA (US)

(21) Appl. No.: 16/154,590

(22) Filed: Oct. 8, 2018

Related U.S. Application Data
(63) Continuation-in-part of application No. 15/629,538, filed on Jun. 21, 2017, now abandoned.

(51) Int. Cl. B62D 33/08; B62D 53/06

(52) U.S. Cl. CPC B62D 33/08; B62D 53/06

(57) ABSTRACT

A height-adjustable enclosed semitrailer having a plurality of adjustable vertical supports for raising and lowering the roof of an enclosure, the enclosure comprising a plurality an overhanging upper body in some embodiments, and a retractable rearward door adapted to retract upwardly into a spool affixed to the roof.

### BACKGROUND

### Field of the Invention

This invention relates to semitrailers and more particularly relates to a height-adjustable enclosed semitrailer with telescoping vertical supports.

### Description of the Related Art

Enclosed semitrailers for the hauling of freight and cargo are known to the art. Most freight is typically carried in an enclosed 53 foot semitrailer, towed by a ten-wheeled tractor over the highway. Traditional enclosed trailers have been used for more than fifty years. The enclosure is typically built on top of a platform and chassis and comprising five sides. The enclosure sides, floor and top may be fabricated from flexible or rigid materials, typically metal alloy or polymeric materials. The purpose of semitrailer enclosures is to ensure that the cargo is protected during transport both from dirt and the force of air.

With this protection afforded by enclosed semitrailers come a number of inefficiencies and shortcomings, mainly air resistance. Enclosed trailers are built to be as tall as possible to enclose the maximum possible quantity of cargo. Because the trailer enclosures tend to be constructed to the maximum height, width and length permitted by the law, the cargo does not typically fill the vertical height of the trailers. Many enclosed trailers exceed 13 feet in height but are commonly used to haul freight rising only a few feet from the interior horizontally-disposed platform. This configuration and heightened trailer reduces aerodynamics and increases air drag resulting in significantly reduced fuel inefficiency and increased costs to all involved.

There exist no efficient adjustable height semitrailers in the art. The rearward end of the enclosure is usually equipped with doors to allow access to the internal cargo and the art teaches no way of reducing the height of these doors. Additionally, vertical supports giving rigidity and strength to the enclosure are not easily adjusted.

The present invention is designed to overcome these shortcomings and to ensure that cargo may be positioned in very close proximity to the upper and lower surfaces of the enclosure, thereby reducing drag.

### SUMMARY

From the foregoing discussion, it should be apparent that a need exists for a height-adjustable enclosed semitrailer with telescoping vertical supports. Beneficially, such a projectile would enhance aerodynamic characteristics of a semitrailer by reducing drag.

The present invention has been developed in response to the present state of the art, and in particular, in response to the problems and needs in the art that have not yet been fully solved by currently available firearm projectiles and shotgun slugs. Accordingly, the present invention has been developed to provide a height-adjustable enclosure semitrailer, the semitrailer comprising: a chassis having a horizontally-disposed platform adapted to support cargo; a plurality of axles; an enclosure affixed to the platform comprising: a main body affixed to the chassis having upwardly-rising sidewalls; an upper body affixed to the vertical supports, the upper body having downwardly-protruding sidewalls which overlap the upwardly-rising sidewalls of the main body; a plurality of telescoping vertical supports adapted to automatically raise and lower an upper body of the enclosure, the telescoping vertical supports affixed exteriorly to main body and affixed to interior surfaces of the downwardly-protruding sidewalls of the upper body; wherein the upper body is adapted to raise and lower with the vertical supports; and a retractable roll away rearward door affixed between the downwardly-protruding sidewalls and positioned above two swinging doors.

The vertical supports may be affixed at regularly-spaced intervals to an BD exterior surface of the upwardly-rising sidewalls.

The vertical supports may comprise an exterior sleeve and an interior cylindrical member adapted to slide longitudinally within the exterior sleeve.

The vertical supports, in some embodiment, comprise an exterior sleeve and an interiorly-received threaded rod adapted to rotate axially within the exterior sleeve.

The vertical supports may also comprise a plurality of U-shaped fasteners bolted to the exterior sleeve.

In various embodiments, the semitrailer further comprises a plurality of nuts, each nut receiving a portion of the threaded rod, each nut positioned between a fastener.

The vertical supports may also comprise a beveled-gear affixed to a terminal end of the threaded rod.

The vertical supports may further comprise an automatically-actuated jackscrew.

In various embodiments, the vertical supports comprise a plate for affixing to a downwardly-protruding sidewall.

The semitrailer may alternatively further comprise four or more overhanging panels.

The semitrailer may also further comprise two or more drive shafts affixed to the chassis.

The semitrailer may further comprise two or more drive shafts affixed to the chassis, each drive shaft comprising a plurality of gears, each gear for engaging a beveled gear of a vertical support member.

A second height-adjustable enclosure semitrailer is provided, the semitrailer comprising: a chassis having a horizontally-disposed platform adapted to support cargo; a plurality of axles; an enclosure affixed to the platform comprising: a main body affixed to the chassis having upwardly-rising sidewalls; an upper body affixed to the vertical supports, the upper body having downwardly-protruding sidewalls which overlap the upwardly-rising sidewalls of the main body; a plurality of telescoping vertical supports adapted to automatically raise and lower an upper body of the enclosure, the telescoping vertical supports affixed exteriorly to main body and affixed to interior surfaces of the downwardly-protruding sidewalls of the upper body; wherein the vertical supports comprise an exterior sleeve and an interiorly-received threaded rod adapted to rotate axially within the exterior sleeve; wherein the vertical supports comprise a plurality of U-shaped fasteners bolted to the exterior sleeve and comprise a plurality of nuts, each nut receiving a portion of the threaded rod, each nut positioned between a fastener; wherein the vertical supports comprise a beveled-gear affixed to a terminal end of the threaded rod; wherein the upper body is adapted to raise and lower with the vertical supports; and a retractable roll away rearward door affixed between the downwardly-protruding sidewalls and positioned above two swinging doors.

The semitrailer may also comprise two or more drive shafts affixed to the chassis.

In still further embodiments, the semitrailer comprises two or more drive shafts affixed to the chassis, each drive shaft comprising a plurality of gears, each gear for engaging a beveled gear of a vertical support member.

Further objects and advantages of this invention will become apparent from the following description referring to the accompanying drawing, and the features of novelty which characterize this invention will be pointed out with particularity in the claims appended to and forming a part of this specification.

Reference throughout this specification to features, advantages, or similar language does not imply that all of the features and advantages that may be realized with the present invention should be or are in any single embodiment of the invention. Rather, language referring to the features and advantages is understood to mean that a specific feature, advantage, or characteristic described in connection with an embodiment is included in at least one embodiment of the present invention. Thus, discussion of the features and advantages, and similar language, throughout this specification may, but do not necessarily, refer to the same embodiment.

Furthermore, the described features, advantages, and characteristics of the invention may be combined in any suitable manner in one or more embodiments. One skilled in the relevant art will recognize that the invention may be practiced without one or more of the specific features or advantages of a particular embodiment. In other instances, additional features and advantages may be recognized in certain embodiments that may not be present in all embodiments of the invention.

These features and advantages of the present invention will become more fully apparent from the following description and appended claims, or may be learned by the practice of the invention as set forth hereinafter.

### BRIEF DESCRIPTION OF THE DRAWINGS

In order that the advantages of the invention will be readily understood, a more particular description of the invention briefly described above will be rendered by reference to specific embodiments that are illustrated in the appended drawings. Understanding that these drawings depict only typical embodiments of the invention and are not therefore to be considered to be limiting of its scope, the invention will be described and explained with additional specificity and detail through the use of the accompanying drawings, in which:

FIG. 1 is a bottom side perspective view illustrating one embodiment of a height-adjustable enclosed semitrailer in accordance with the present invention;

FIG. 2 is a rearward side perspective view illustrating one embodiment of a height-adjustable enclosed semitrailer in accordance with the present invention;

FIG. 3 is a sectioned side perspective view illustrating one embodiment of a height-adjustable enclosed semitrailer in accordance with the present invention;

FIG. 4A is a side perspective view illustrating one embodiment of telescoping vertical support of a height-adjustable enclosed semitrailer in accordance with the present invention;

FIG. 4B is a side perspective view illustrating one embodiment of telescoping vertical support of a height-adjustable enclosed semitrailer in accordance with the present invention;

FIG. 4C is a side perspective view illustrating one embodiment of telescoping vertical support of a height-adjustable enclosed semitrailer in accordance with the present invention;

FIG. 5A is a rear side perspective view illustrating one embodiment of telescoping vertical support of a height-adjustable enclosed semitrailer in accordance with the present invention;

FIG. 5B is a rear side perspective view illustrating one embodiment of telescoping vertical support of a height-adjustable enclosed semitrailer in accordance with the present invention;

FIG. 5C is a rear perspective view illustrating one embodiment of telescoping vertical support of a height-adjustable enclosed semitrailer in accordance with the present invention;

FIG. 6 is a side perspective view illustrating one embodiment of telescoping vertical support of a height-adjustable enclosed semitrailer in accordance with the present invention;

FIG. 7A is a side perspective view illustrating one embodiment of turn screw drive in accordance with the present invention; and

FIG. 7B is a side perspective view illustrating one embodiment of turn screw drive in accordance with the present invention.

### DETAILED DESCRIPTION

Reference throughout this specification to “one embodiment,” “an embodiment,” or similar language means that a particular feature, structure, or characteristic described in connection with the embodiment is included in at least one embodiment of the present invention. Thus, appearances of the phrases “in one embodiment,” “in an embodiment,” and similar language throughout this specification may, but do not necessarily, all refer to the same embodiment.

Furthermore, the described features, structures, or characteristics of the invention may be combined in any suitable manner in one or more embodiments. In the following description, numerous specific details are provided to provide a thorough understanding of embodiments of the invention. One skilled in the relevant art will recognize, however, that the invention may be practiced without one or more of the specific details, or with other methods, components, materials, and so forth. In other instances, well-known structures, materials, or operations are not shown or described in detail to avoid obscuring aspects of the invention.

The schematic flow chart diagrams included herein are generally set forth as logical flow chart diagrams. As such, the depicted order and labeled steps are indicative of one embodiment of the presented method. Other steps and methods may be conceived that are equivalent in function, logic, or effect to one or more steps, or portions thereof, of the illustrated method. Additionally, the format and symbols employed are provided to explain the logical steps of the method and are understood not to limit the scope of the method. Although various arrow types and line types may be employed in the flow chart diagrams, they are understood not to limit the scope of the corresponding method. Indeed, some arrows or other connectors may be used to indicate only the logical flow of the method. For instance, an arrow may indicate a waiting or monitoring period of unspecified duration between enumerated steps of the depicted method. Additionally, the order in which a particular method occurs may or may not strictly adhere to the order of the corresponding steps shown.

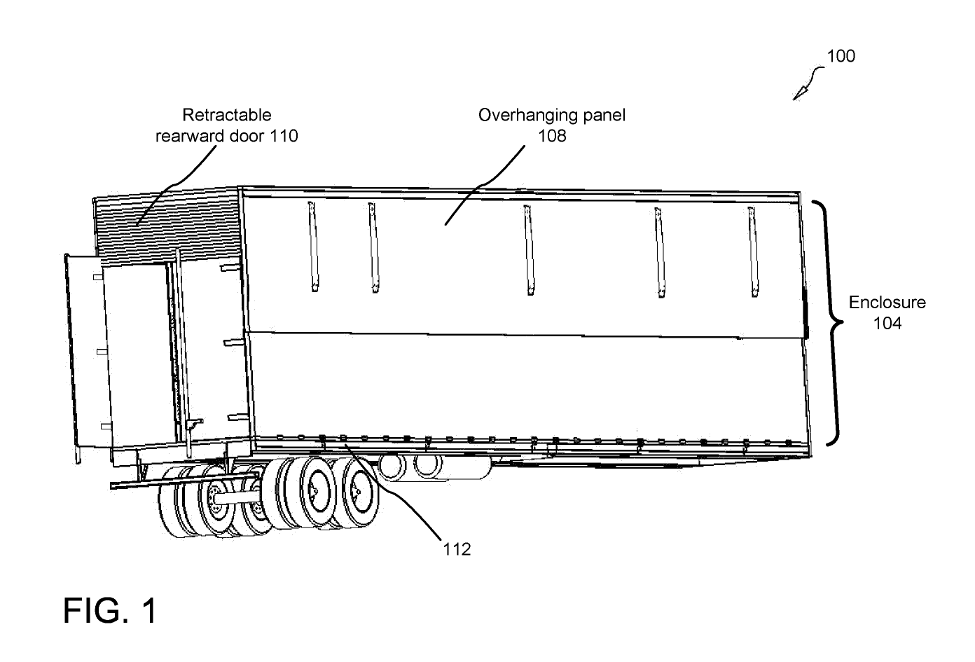

FIG. 1 is a bottom side perspective view illustrating one embodiment of a height-adjustable enclosed semitrailer 100 in accordance with the present invention.

The semitrailer 100 comprises a chassis 112 upon which an enclosure 104 is built out of a metal, glass, metal alloy or polymeric materials such as steel, aluminum, nylon, fiberglass, and the like. The enclosure 104 may comprise flexible organic or polymeric material or skin, such as nylon or leather. The enclosure 104 may comprise ribs, lattice, rods, or framework necessary to support the enclosure.

The roof of the enclosure may be hingedly connected to two or more overhanging panels 108 which slide vertically relative to the chassis 112 and overhang sidewalls of the enclosure fixed in place vertically. In other embodiments, such as that shown, the overhanging panels 108 are affixed at approximately 90 degree angles to the roof and formed as a single piece with the roof or otherwise affixed thereto.

The semitrailer 100 comprises a retractable rearward door 110 (roll away) which retracts into a spool affixed to a lower side of the roof of the enclosure 104. The spool rotates to retract and extract the door as needed to adjust the height of the trailer 100.

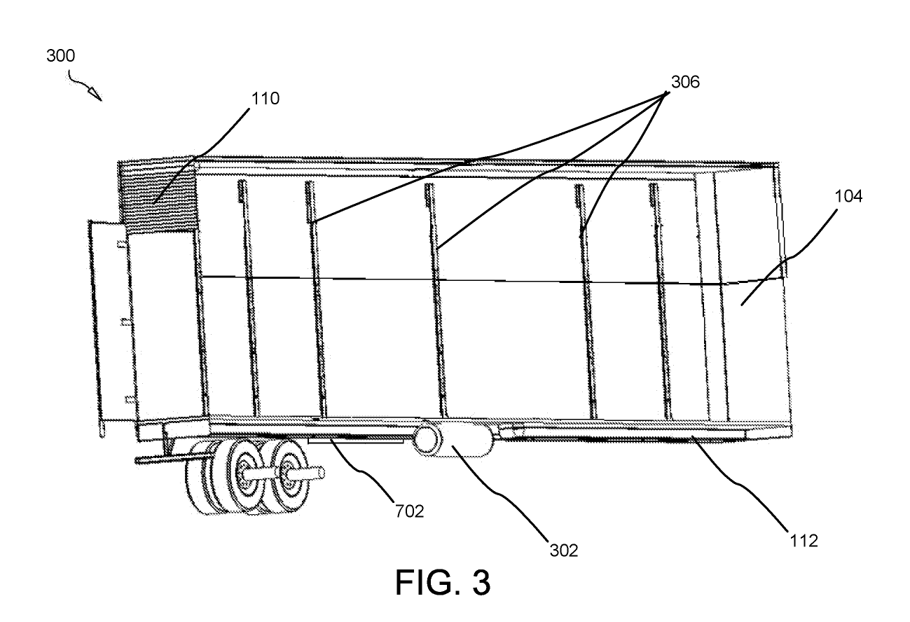

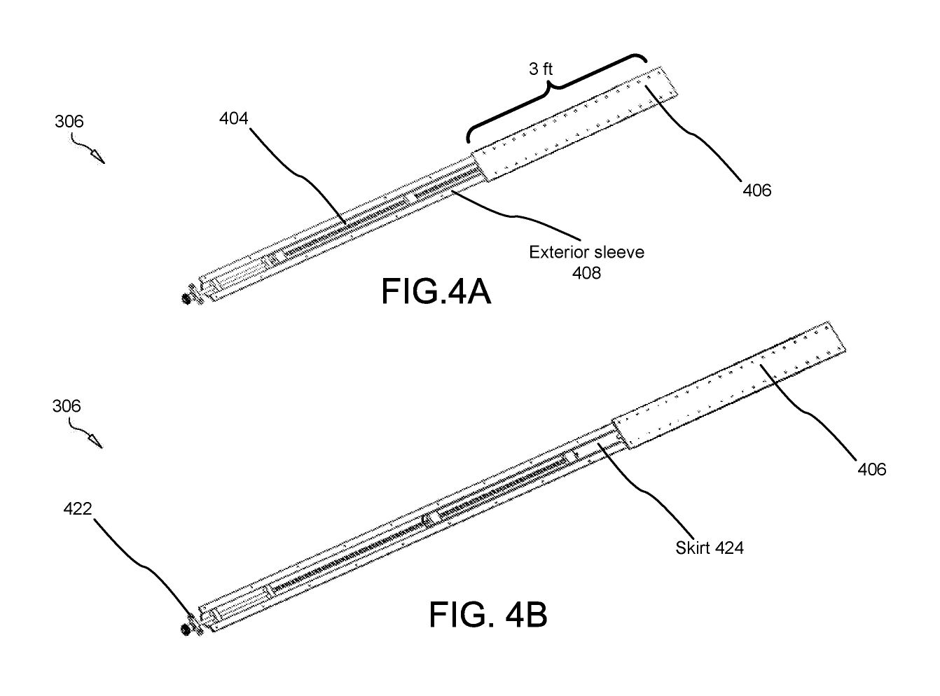

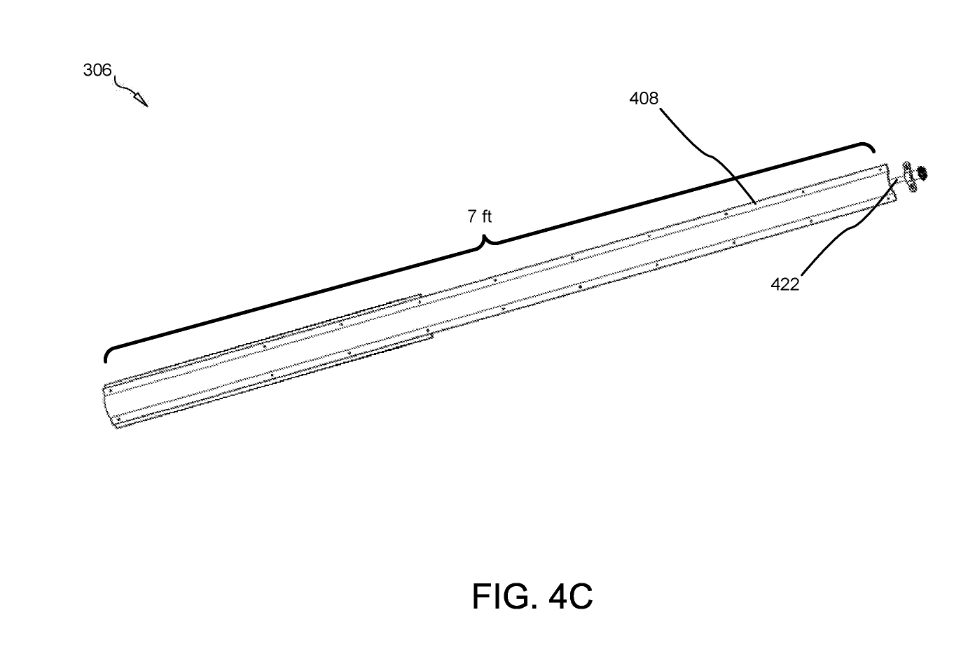

A plurality of vertical supports 306 (shown below in reference to FIG. 3-4C) are affixed at a proximal end to the chassis 112 or a horizontally-disposed platform on the chassis 112.

By selectively pressurizing and depressurizing one or more hydraulic cylinders, or pneumatic cylinders, disposed beneath the horizontally-disposed platform, the vertical supports may be raised or lowered resulting in consequential raising and lowering of the roof to reduce drag on the semitrailer during transport. Reducing the height also improves safety to an operator as the semitrailer is less likely to blow over in crosswinds.

The roof of the semitrailer may be raised or lowered within the confines of the enclosure to bring cargo into closer proximity with the roof the trailer to facilitate reduced drag. The roof may be automatically raised when unloading cargo to provide space to an operator or fork lift operator. When the trailer is not being used for hauling cargo, the roof may be lowered to the reduce the profile of the trailer. of travel of the hydraulic cylinders, or alternatively may be raised to the maximum extent of travel of the hydraulic cylinders or jack screws.

The height of the enclosure 104 in its extended position is ten feet.

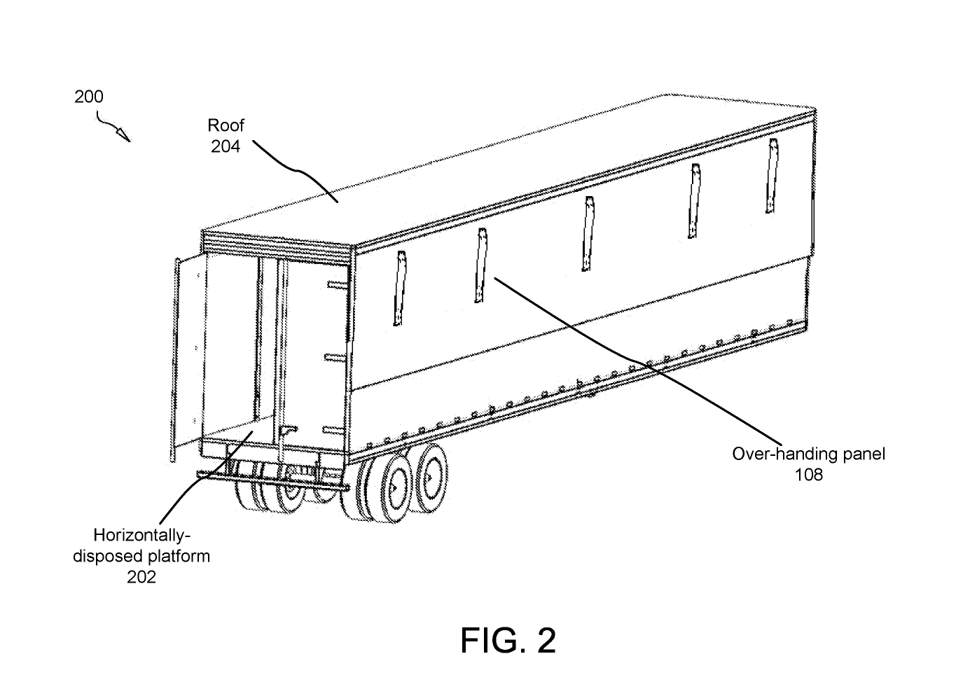

FIG. 2 is a rearward side perspective view illustrating one embodiment of a height-adjustable enclosed semitrailer 200 in accordance with the present invention.

As shown, the horizontally-disposed platform 202 is affixed to the chassis 112 or formed with the chassis 112 as an integrated piece. The height of the horizontally-disposed platform above a ground surface is approximately three feet.

FIG. 3 is a sectioned side perspective view illustrating one embodiment of a height-adjustable enclosed semitrailer 300 in accordance with the present invention.

The vertical supports 108 are interior to the enclosure 104. An hydraulic cylinder 302 or air tank is disposed beneath the chassis for raising and lowering the vertical supports 108. To ensure a useful operating range to conventional hydraulic cylinders, such hydraulic cylinders must be of sufficient size to position below the horizontally-disposed platform 202.

A drive shaft 702 (further described below) is affixed to the chassis 112.

FIG. 4A is a side perspective view illustrating one embodiment of telescoping vertical support 306 of a height-adjustable enclosed semitrailer in accordance with the present invention.

The vertical supports 306 typically have a maximum extended length which may restrict the usable cargo space when the vehicle is not used for vehicle hauling. Over extending the vertical supports 306 may cause full or partial collapse of the enclosure.

The vertical supports 306 comprises an exterior member or sleeve 408 having a plate 406 for affixing to one of a chassis 112 and the roof of the enclosure. The length of the plate 406 may be approximately three feet. A threaded rod 404, shaft, pipe, or cylindrical member may insert into the vertical support 306. The threaded rod 404 may be exteriorly threaded to engage various nuts, fasteners, or mating interiorly threaded components of the vertical support 306. The threaded rod 404 may act as a jack screw, raising and lowering the roof or upper body of the trailer 100.

FIG. 4B is a side perspective view illustrating one embodiment of telescoping vertical support 306 of a height-adjustable enclosed semitrailer in accordance with the present invention.

The vertical support 306, in the shown embodiment, comprises an interior member 422 which slides longitudinally away from the exterior member 408 for raising the roof of the enclosure. In the shown embodiment, the interior member comprises a threaded cylindrical rod which extends through the horizontally-disposed platform and engages a plurality hydraulically- or pneumatically-operated gears operating to raise the roof using jack screws. The vertical supports may also telescope instead of using jack screws to raise and lower the roof, or may relay on hydraulic pistons to raise and lower roof.

FIG. 4C is a side perspective view illustrating one embodiment of telescoping vertical support 306 of a height-adjustable enclosed semitrailer in accordance with the present invention.

As shown, the interior member 422 inserts into the exterior member 408. The length of the vertical support 306 in its extended position is approximately seven feet plus a few inches in some embodiments for the portion extending below the horizontally-disposed platform 202.

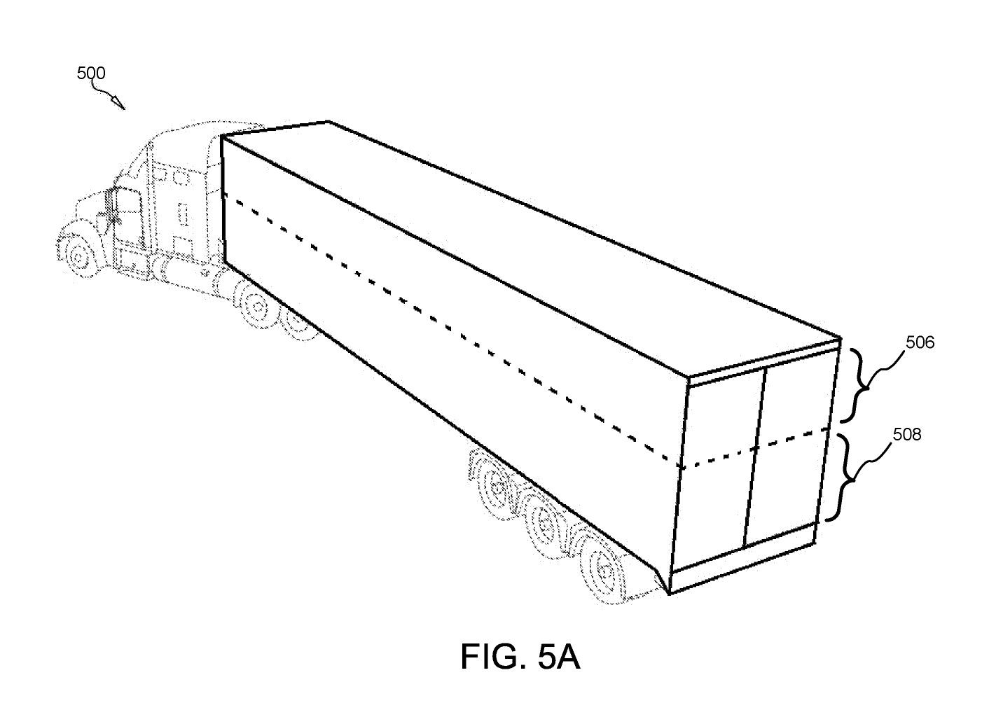

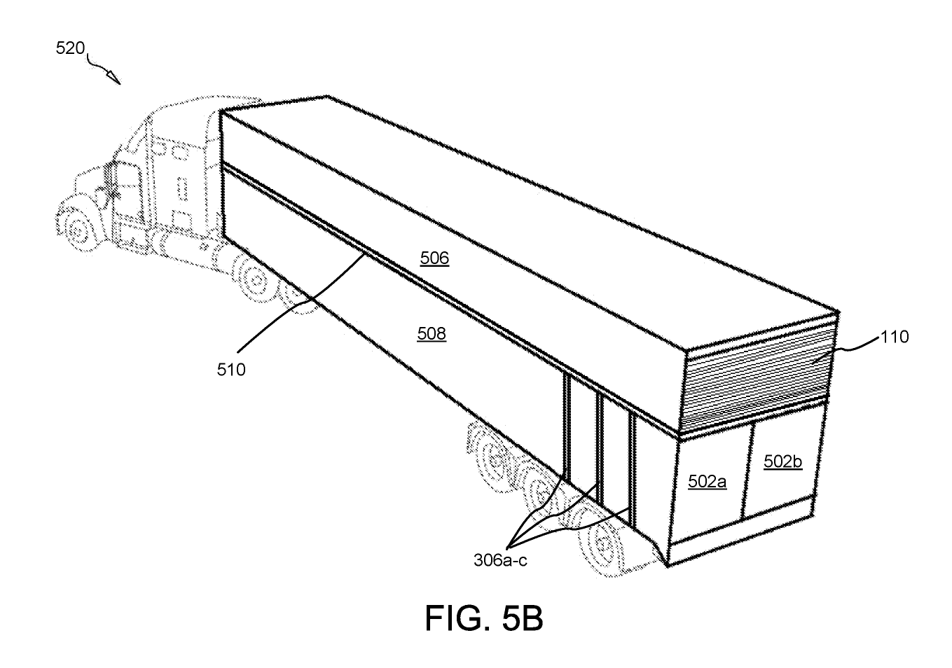

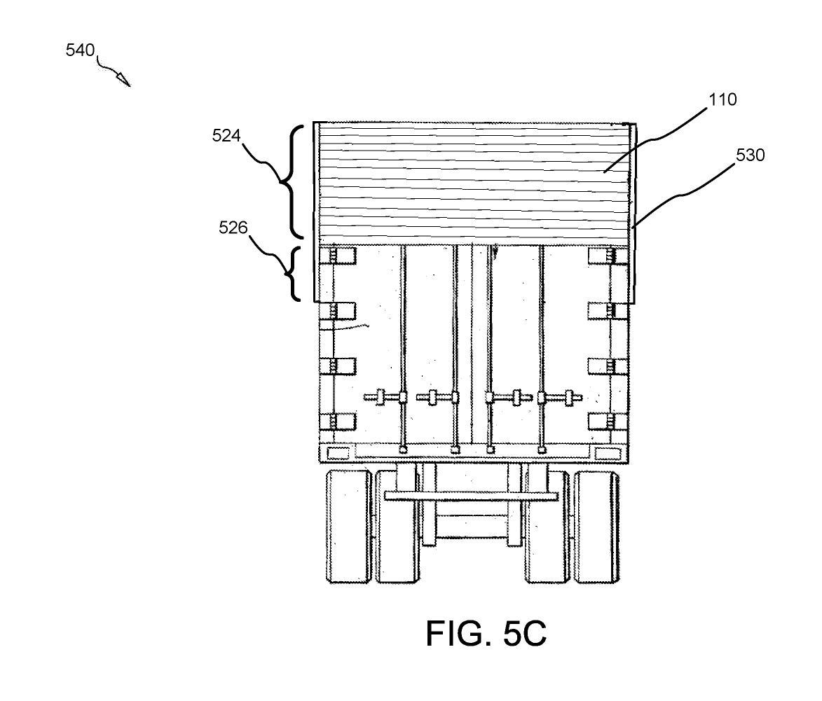

FIG. 5A is a rear side perspective view illustrating one embodiment of telescoping vertical support of a height-adjustable enclosed semitrailer 500 in accordance with the present invention.

The roll away door is indicated at 110. The main body of the trailer is indicated at 508 and the upper body indicated at 506. The main body 508 is 7 feet tall in the shown embodiment. The upper body 506 is cut from the main body and is between 5 feet and 7.5 feet tall. In various embodiments, after the upper body 506 is cut from the main body 508, two or more feet is added to the upper body 506 such that the upper body 508 overlaps the main body 508 when traveling up and down from extended to retracted positions.

FIG. 5B is a rear side perspective view illustrating one embodiment of telescoping vertical support of a height-adjustable enclosed semitrailer 520 in accordance with the present invention.

A top rail 510 is welded or bolted to the top of the main body 508 formed from steel, aluminum, titanium or a metal allow. A rail 510 may likewise be welded or bolted to the bottom edge of the upper body 506.

The telescoping vertical support member 306 may position outside against the exterior surface of the main body 508 at evenly-spaced intervals, such as every 3 feet. These vertical support members 306 may position, or be disposed, within the sidewalls of the upper body 506 because the upper body 506 overlaps the lower body.

FIG. 5C is a rear perspective view illustrating one embodiment of telescoping vertical support of a height-adjustable enclosed semitrailer 540 in accordance with the present invention.

The roll away door 110 may be affixed to the upper body 506 and/or the main body 508. The sidewall is indicated at 530 comprises the lateral wall of the upper body 506 and the appended lower overlapping wall.

As shown, a 2 foot sidewall portion 526 appended to the lower edge of the upper body 506 juts downwardly overlapping the main body 508. The height 524 of the upper body portion 506 is 5 feet in the shown embodiment (not drawn to scale).

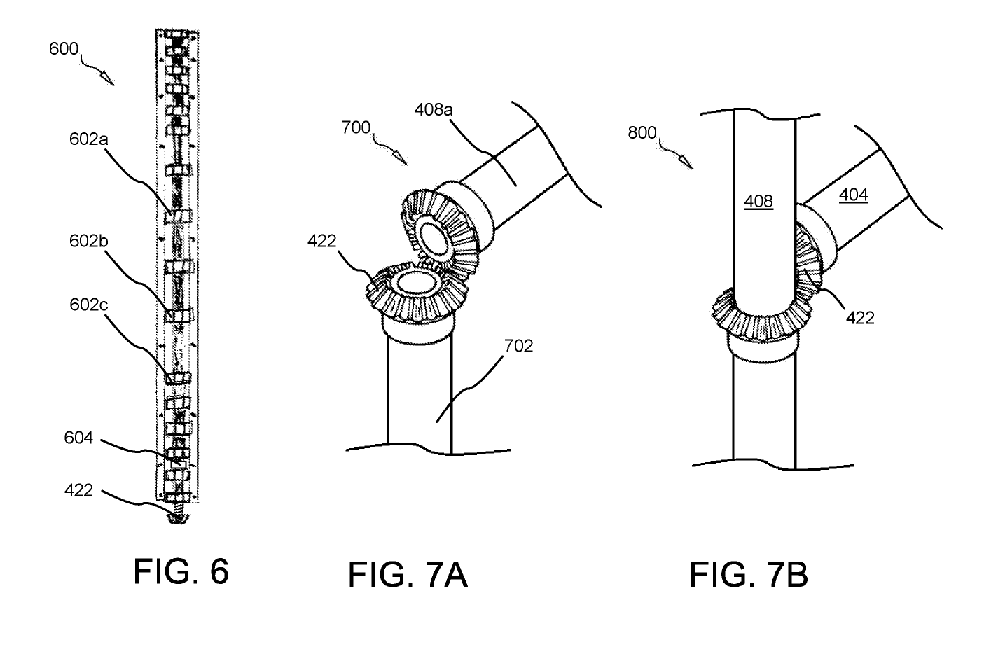

FIG. 6 is a side perspective view illustrating one embodiment of telescoping vertical support of a height-adjustable enclosed semitrailer in accordance with the present invention.

The telescoping vertical support member 600 comprises a plurality of U-shaped fasteners 602. These fasteners 602 may be interiorly threaded to engage an exteriorly threaded rod 404. These fasteners are welded, bolted, screwed, or otherwise affixed to an exterior sleeve of the vertical support member 600 or chassis of the vertical support member. Various nuts 604 may position between fasteners 604 such that the nuts hold the threaded rod 404 as it rotates axially to raise or lower the upper body 606.

The top portion of the vertical support member 600 bolts to the interior surface of the sidewall 530. The lower portion of the vertical support member 600 bolts to the exterior surface of the main body 508.

FIG. 7A-7B depict side perspective views illustrating one embodiment of turn screw drive in accordance with the present invention.

The lower portion and/or or under carriage and/or chassis of the main body 508 comprises a plurality drive shafts 408, beveled gears 422, sprockets, and chains configured to force axial rotation of each of the threaded rods 404 in unison by activation of a semitruck's air drive pumps, electric battery pumps, or hydraulic pumps. The components collectively comprise a turn screw drive for the trailer 100.

The drive shaft 702 runs front to back beneath the main body 508. Two or more drive shafts may traverse underneath the main body 508. In the shown embodiment, the gear 422 at the bottom of the threaded rod 404 mates with a corresponding beveled gear or sprocket on the drive shaft 702. In alternative embodiments, the beveled gear 422 are interconnected using chain.

The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A height-adjustable enclosure semitrailer, the semitrailer comprising:
a chassis having a horizontally-disposed platform adapted to support cargo;
a plurality of axles;
an enclosure affixed to the platform comprising:
a main body affixed to the chassis having upwardly-rising sidewalls;
an upper body affixed to the vertical supports, the upper body having downwardly-protruding sidewalls which overlap the upwardly-rising sidewalls of the main body;
a plurality of telescoping vertical supports adapted to automatically raise and lower an upper body of the enclosure, the telescoping vertical supports affixed exteriorly to main body and affixed to interior surfaces of the downwardly-protruding sidewalls of the upper body;
wherein the upper body is adapted to raise and lower with the vertical supports; and
a retractable roll away rearward door affixed between the downwardly-protruding sidewalls and positioned above two swinging doors.

2. The semitrailer of claim 1, wherein the vertical supports are affixed at regularly-spaced intervals to an exterior surface of the upwardly-rising sidewalls.

3. The semitrailer of claim 1, wherein the vertical supports comprise an exterior sleeve and an interior cylindrical member adapted to slide longitudinally within the exterior sleeve.

4. The semitrailer of claim 1, wherein the vertical supports comprise an exterior sleeve and an interiorly-received threaded rod adapted to rotate axially within the exterior sleeve.

5. The semitrailer of claim 4, wherein the vertical supports comprise a plurality of U-shaped fasteners bolted to the exterior sleeve.

6. The semitrailer of claim 5, further comprising a plurality of nuts, each nut receiving a portion of the threaded rod, each nut positioned between a fastener.

7. The semitrailer of claim 4, wherein the vertical supports comprise a beveled-gear affixed to a terminal end of the threaded rod.

8. The semitrailer of claim 1, wherein the vertical supports comprise an automatically-actuated jackscrew.

9. The semitrailer of claim 1, wherein the vertical supports comprise a plate for affixing to a downwardly-protruding sidewall.

10. The semitrailer of claim 1, further comprising four or more overhanging panels.

11. The semitrailer of claim 1, further comprising two or more drive shafts affixed to the chassis.

12. The semitrailer of claim 1, further comprising two or more drive shafts affixed to the chassis, each drive shaft comprising a plurality of gears, each gear for engaging a beveled gear of a vertical support member.

13. A height-adjustable enclosure semitrailer, the semitrailer comprising:
a chassis having a horizontally-disposed platform adapted to support cargo;
a plurality of axles;
an enclosure affixed to the platform comprising:
a main body affixed to the chassis having upwardly-rising sidewalls;
an upper body affixed to the vertical supports, the upper body having downwardly-protruding sidewalls which overlap the upwardly-rising sidewalls of the main body;
a plurality of telescoping vertical supports adapted to automatically raise and lower an upper body of the enclosure, the telescoping vertical supports affixed exteriorly to main body and affixed to interior surfaces of the downwardly-protruding sidewalls of the upper body;
wherein the vertical supports comprise an exterior sleeve and an interiorly-received threaded rod adapted to rotate axially within the exterior sleeve;
wherein the vertical supports comprise a plurality of U-shaped fasteners bolted to the exterior sleeve and comprise a plurality of nuts, each nut receiving a portion of the threaded rod, each nut positioned between a fastener;
wherein the vertical supports comprise a beveled-gear affixed to a terminal end of the threaded rod;
wherein the upper body is adapted to raise and lower with the vertical supports; and
a retractable roll away rearward door affixed between the downwardly-protruding sidewalls and positioned above two swinging doors.

14. The semitrailer of claim 13, further comprising two or more drive shafts affixed to the chassis.

15. The semitrailer of claim 13, further comprising two or more drive shafts affixed to the chassis, each drive shaft comprising a plurality of gears, each gear for engaging a beveled gear of a vertical support member.
